(19) United States
(12) Patent Application Publication
(10) Pub. No.: US 2013/0042757 A1
(43) Pub. Date: Feb. 21, 2013

(54) FILTERING METHOD FOR A GEAR TRANSMISSION

(71) Applicant: Heiko Eberle, Lambsheim (DE)

(72) Inventor: Heiko Eberle, Lambsheim (DE)

(73) Assignee: MANN+HUMMEL GMBH, Ludwigsburg (DE)

(21) Appl. No.: 13/586,333

(22) Filed: Aug. 15, 2012

(30) Foreign Application Priority Data
Aug. 16, 2011 (DE) 102011110195.4

(51) Int. Cl. B01D 50/00; B03C 3/017; B01D 45/12

(52) U.S. Cl. 95/70; 95/273; 95/287; 95/268

(57) ABSTRACT

A filter has a filter element that removes oil from an oil-containing air stream that is supplied to the filter from a gear transmission of a machine tool or of a compressor. The air-containing air stream upon passing through the filter is separated into a clean air stream and into an oil stream. A return line is provided that returns the oil stream to the gear transmission.

### CROSS REFERENCE TO RELATED APPLICATION

Priority is claimed based Germany patent application no. 102011110195.4, filed Aug. 16, 2011, the entire disclosure of which is incorporated herein by reference.

### TECHNICAL FIELD

This disclosure relates generally to an oil separation filter filtration method for a gear transmission having at least one filter element for oil removal from an air stream containing entrained oil and originating from a gear transmission of a machine tool or of a compressor.

### BACKGROUND OF THE INVENTION

According to the prior art, the filters known up to now for removal of oil from an airstream that contains entrained oil originating from a gear transmission of a machine tool or of a compressor have the disadvantage that the oil that is removed from the oil-containing airstream is lost because the separated oil is released as oil mist into the environment or is discharged into waste oil barrels, for example. The separated oil must therefore be continuously replaced with fresh oil in order to protect the gear transmission from damage.

### SUMMARY OF THE INVENTION

It is therefore an object of the present invention to provide a filter with which the supply of fresh oil can be avoided at least almost completely in the future.

In accordance with the present invention, this is achieved with a filter with at least one filter element for oil removal from an oil-containing air stream that, originating from a gear transmission of a machine tool or of a compressor, is supplied to the filter, wherein the oil-containing air stream upon passing through the filter is divided into a clean air stream and an oil stream and the filter comprises a return line for returning the oil stream to the gear transmission. Accordingly, the oil that has been separated from the air stream is returned to the gear transmission so that no fresh oil or only a small quantity of fresh oil must be supplied to the gear transmission. Accordingly, the operating costs of the gear transmission are significantly reduced and operation of the gear transmission is simplified.

Expediently, the filter can also have a supply line for supplying the oil-containing air stream to the filter.

In a preferred embodiment, the clean airstream can be discharged to the environment. In this case, the filter can be provided with an air outlet opening. The filter can also have a discharge line for discharging the clean air stream.

In a further embodiment, it is however also possible that the clean air stream is supplied to an intake air filter element for filtering intake air that is provided for the compressor. In this case, the discharge line can extend from the filter to the intake air filter element so that the clean air stream serves as intake air for the compressor.

In order to optimize the filtration action, the filter can be of a two-stage configuration with a main separator for separating large oil droplets and an after separator for separating small oil droplets.

In a further preferred embodiment, the main separator can be a centrifugal separator that is especially well-suited for separating large oil droplets.

It is however also possible that the main separator is an electrostatic separator.

Also, the main separator can also be embodied as a plate separator.

In practice, a coalescence separator has been found to be well suited as an after separator.

However, a capillary separator may also be used as an after separator.

However, it is also possible to employ a nanofilter element as an after separator.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

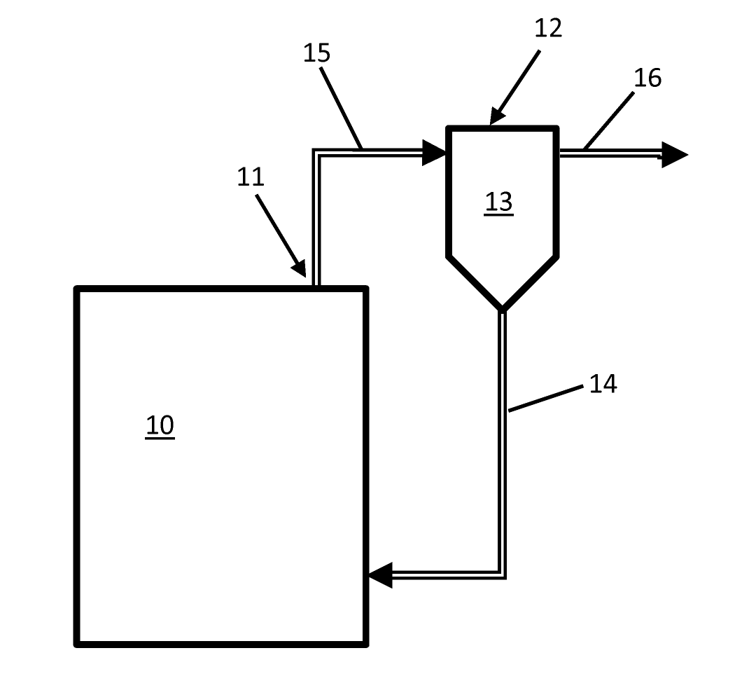

The sole FIGURE FIG. 1 schematically depicts an oil separation filter applied to a gear transmission consistent with the teachings of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components and method steps related to a an oil separating filtration method for separating oil from an oil-containing air stream venting from a gear transmission. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

FIG. 1 schematically depicts a gear transmission 10 of a machine tool or of a compressor that is provided with a venting opening 11. In a machine tool, during operation the oil-containing air in the gear transmission 10 is expanding due to heating so that the gear transmission must be vented. In case of a compressor, on the other hand, a compressor screw cannot be sufficiently sealed relative to the gear transmission so that the oil-containing air escapes into the gear transmission and the gear transmission must also be vented in this case. For this purpose, the oil-containing air can be discharged through the venting opening 11 of the gear transmission.

The filter 12 is provided with a filter element 13, a return line 14 for returning an oil stream to the gear transmission 10, and a supply line 15 for supplying an oil-containing air stream to the filter 12. Moreover, the filter 12 is provided with a discharge line 16 for discharging a clean air stream. Accordingly, in the filter 12 the oil-containing air stream is separated into an oil stream that is returned via the return line 14 to the gear transmission and an air stream that, by means of the supply line 15, is either discharged into the environment or is supplied to an air intake filter element, not illustrated in detail in this context, for filtering intake air that is supplied to the compressor. The filter 12 is preferably of a two-stage configuration provided with a main separator and an auxiliary separator (after separator).

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims The invention is defined solely by the appended claims including any amendments made during the pendency of this application and all equivalents of those claims as issued.

1. A method of removing oil from an oil contaminated air stream of a gear transmission of an air compressor or machine tool, comprising:
providing a gear transmission having an air vent opening and an oil return port for oil returning to the gear transmission;
providing a filter having within at least one filter element operable to remove oil from an oil-containing air stream;
providing an oil return line connected at one end to an oil sump of said filter and at an opposing end to said oil return port;
filtering said oil-containing air stream flowing from said transmission by flowing said contaminated air stream through said filter element to separate into an oil stream and a clean air stream; and
communicating said oil stream from said filter to back into said gear transmission through said oil return line.

2. The method according to claim 1 wherein
before practicing said filtering step the method further comprises
providing a supply line connecting said air vent opening of said gear transmission to said filter to communicate said oil-containing air stream to said filter.

3. The method according to claim 2, wherein
before said filtering step the method further comprises
providing a discharge line connected to said filter and discharging said clean air stream from said filter.

4. The method according to claim 3, wherein
said providing a discharge line step is practice by discharging said clean air stream through said discharge line into an air intake filter element of an air intake filter of said air compressor.

5. The method according to claim 1, wherein
in said filtering step, said filter includes
a main separator separating large oil droplets from said oil-containing air stream;
an after separator separating remaining small oil droplets from said oil-containing air stream after said main separator;
wherein said main separator and said after separator are two separate parts forming a two-part configuration;
wherein separated oil from said main separator and said after separator flow to said return line.

6. The method according to claim 5, wherein
in said filtering step, said main separator is a centrifugal separator.

7. The method according to claim 5, wherein
in said filtering step, said main separator is an electrostatic separator.

8. The method according to claim 5, wherein
in said filtering step, said main separator is a plate separator.

9. The method according to claim 5, wherein
in said filtering step, said after separator is a coalescence separator.

10. The method according to claim 5, wherein
in said filtering step, said after separator is a capillary separator.
